(19) United States
(12) Patent Application Publication
(10) Pub. No.: US 2007/0019115 A1
(43) Pub. Date: Jan. 25, 2007

(54) Television broadcasting receiver

(75) Inventor: Yuji Umeda, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/485,489

(22) Filed: Jul. 13, 2006

(30) Foreign Application Priority Data
Jul. 22, 2005 (JP) 2005-212370

(51) Int. Cl. H04N 5/50; H04N 5/63

(52) U.S. Cl. 348/730; 348/731; 348/570

(57) ABSTRACT

The invention provides a television broadcasting receiver provided with a plurality of tuners which allows a user to set whether or not power is supplied to the respective tuners. A setting screen for setting whether or not power is supplied to the respective tuners is displayed on a display section 107, an instruction from the user is judged/acquired by a key judgment section 1133 and control section 110, the acquired setting contents are stored in a storage section 109 and the control section 110 and a tuner power control circuit 111 control power supplies to the respective tuners (tuners 1 to 3) according to the setting contents.

The present application is based on and claims priority of Japanese patent application No. 2005-212370 filed on Jul. 22, 2005, the entire contents of which are hereby incorporated by reference.

### BACKGROUND OF THE INVENTION

1. Field of the Invention

The present invention relates to a television broadcasting receiver, and more particularly, to a television broadcasting receiver provided with a plurality of tuners, or a television broadcasting receiver with consideration given to power supplies to the respective tuners.

2. Description of the Related Art

Due to a difference in broadcast wave schemes, difference in frequency bands used, difference between analog and digital or the like, there exist a plurality of tuners corresponding to television broadcast signals (for example, terrestrial digital (or analog) tuner, BS digital (or analog) tuner, CS digital (or analog) tuner). Therefore, a device needs to be provided with a plurality of tuners so as to receive all these or a plurality of television broadcast signals.

However, in the case of the device provided with a plurality of tuners (for example, television and recording/reproducing device), there may be unnecessary tuners depending on the environment of the user (for example, even when a device is provided with a CS digital tuner, the user may not have any antenna corresponding thereto). Furthermore, when the device is operating, not all tuners need to be operated, and rather it is often the case that only one tuner is operating (when so-called “recording another program on a different channel” or the like is being performed, a plurality of tuners operate, but when only one program is being received, only one tuner operates), and therefore supplying power to all these tuners results in unnecessary power consumption. Conventional techniques related to these problems are disclosed in Japanese Patent Laid-Open Publication No. 5-284053, Japanese Patent Laid-Open Publication No. 9-270973 and Japanese Patent Laid-Open Publication No. 10-108115 (Patent Document 1 to 3) or the like.

The conventional techniques disclosed in the above described patent documents are designed to judge whether each tuner is operating or not (whether the user is viewing or not) and automatically turn ON/OFF power supplies to the tuners and antennas. These techniques automatically turn ON/OFF power supplies to tuners or the like that are not used for viewing (tuners that need not be operated) and therefore offer excellent convenience to the user and realize power saving of the device.

However, depending on the user, there may be programs that are usually hardly viewed (tuners that have environments ready to receive those programs yet almost not used) or programs that the user has no interest in viewing in the first place (tuners that have environments ready to receive those programs yet need not be operated). Furthermore, there may be a case where switching to a broadcasting channel received by a specific tuner is preferably avoided (for example, when CS broadcasting is preferably not received by a television receiver or the like installed in an educational institute, or on the contrary, only CS broadcasting is preferably received). On the contrary, as in the case of the conventional techniques disclosed in the above described patent documents, if a power supply to a tuner or the like is automatically turned ON according to the user's selection, even when the user mistakenly presses the operation button of a channel which the user has no interest in viewing in the first place or operates the operation button of a channel which should preferably not be viewed, power is supplied to the tuner corresponding to the channel and display processing on the channel is performed, and therefore the convenience to such a user is reduced and power consumption is also wasted.

### SUMMARY OF THE INVENTION

In view of the above described problems, it is an object of the present invention to provide a television broadcasting receiver provided with a plurality of tuners allowing the user to set whether or not power is supplied to the respective tuners.

The television broadcasting receiver according to a first aspect of the present invention is a television broadcasting receiver provided with a plurality of tuners for receiving broadcast signals of various frequencies, comprising a control section, a storage section, a tuner power control circuit which controls power supplies to the respective tuners and an input section which is an interface for inputs from a user, wherein the user's settings as to whether or not power is supplied to the respective tuners are acquired from the input section, the settings are stored in the storage section and the tuner power control circuit controls power supplies to the respective tuners.

According to the above described construction, the user sets as to whether or not power is supplied to the respective tuners and the power supplies to the respective tuners are controlled according to the setting contents.

The television broadcasting receiver according to a second aspect of the present invention is the television broadcasting receiver according to the first aspect of the present invention, wherein the user is prompted to enter settings as to whether or not power is supplied to the respective tuners at the time of initial setting to use the television broadcasting receiver.

According to the above described construction, settings as to whether or not power is supplied to the respective tuners are performed at the time of initial setting. The “initial setting to use the device” refers to settings of receiving channels or the like which are performed when power is turned ON for the first time after shipment.

The television broadcasting receiver according to a third aspect of the present invention is the television broadcasting receiver according to the first or second aspect of the present invention, wherein when the input from the user to the input section is an instruction for switching to receiving of another broadcast signal and when the tuner which receives the other broadcast signal is a tuner set so as not to perform the power supply, the switching to the receiving of the other broadcast signal is not performed.

According to the above described construction, when, for example, an operation of switching to a CS broadcasting channel is performed while BS broadcasting is being received, if a power supply to the CS tuner has been set to “OFF”, the switching to the CS broadcasting channel is not performed (receiving of BS broadcasting continues).

The television broadcasting receiver according to a fourth aspect of the present invention is the television broadcasting receiver according to the third aspect of the present invention, wherein when an instruction for switching to the receiving of the other broadcast signal is given and the tuner which receives the other broadcast signal is a tuner set so as not to perform the power supply, information thereon is displayed on a screen.

According to the above described construction, when, for example, an operation of switching to a CS broadcasting channel is performed while BS broadcasting is being received, if a power supply to the CS tuner has been set to “OFF”, the switching to the CS broadcasting channel is not performed and such information that “the power supply to the CS tuner has been set to “OFF”” is displayed on a screen.

The television broadcasting receiver according to a fifth aspect of the present invention is the television broadcasting receiver according to the first or second aspect of the present invention, wherein when the input from the user to the input section is an instruction for switching to receiving of another broadcast signal and the tuner which receives the other broadcast signal is a tuner set so as not to perform the power supply, the user is prompted to instruct as to whether or not power is supplied to the tuner to which the power is not supplied and if the instruction from the user to the input section in response thereto is to supply power to the tuner, the tuner power control circuit performs processing of supplying power to the tuner and performs switching to the receiving of the other broadcast signal.

According to the above described construction, when, for example, an operation of switching to a CS broadcasting channel is performed while BS broadcasting is being received, if a power supply to the CS tuner has been set to “OFF”, the user is prompted to instruct as to whether or not power is supplied to the CS tuner and if the user instructs that power should be supplied, power is supplied to the CS tuner and switching to the CS broadcasting channel is performed. The “judgment as to whether or not to perform a power supply to the tuner” means confirming whether or not the user has the intention to view the channel and the instruction as to “whether or not a power supply to the tuner is performed” is an instruction as to “whether or not to perform switching to the channel.” Therefore, when “the user is prompted to instruct as to whether or not power is supplied to the tuner to which the power is not supplied”, a screen for prompting the user to instruct as to “whether or not to perform channel switching” or the like may also be displayed.

The television broadcasting receiver according to a sixth aspect of the present invention is the television broadcasting receiver according to the fifth aspect of the present invention, wherein when the user instructs that power should be supplied to the tuner which receives the other broadcast signal, the storage section is caused to store a setting that the power supply to the tuner is set to “ON.”

According to the above described construction, when, for example, an operation of switching to a CS broadcasting channel is performed while BS broadcasting is being received, if a power supply to the CS tuner has been set to “OFF”, the user is prompted to decide as to whether or not power is supplied to the CS tuner and if the user instructs that power should be supplied, a setting that the power supply to the CS tuner is set to “ON” is stored in the storage section.

The television broadcasting receiver according to a seventh aspect of the present invention is the television broadcasting receiver according to the fifth aspect of the present invention, wherein when the user instructs that power should be supplied to the tuner which receives the other broadcast signal, the setting that the power supply to the tuner is set to “OFF” stored in the storage section is not changed and when the user instructs switching to an operation process that does not require the tuner, the operation process is performed and the power supply to the tuner by the tuner power control circuit is stopped.

According to the above described construction, when, for example, an operation of switching to a CS broadcasting channel is performed while BS broadcasting is being received, if a power supply to the CS tuner has been set to “OFF”, the user is prompted to decide as to whether or not power is supplied to the CS tuner and if the user instructs that power should be supplied, the power is supplied to the CS tuner according to this instruction and switching to the CS broadcasting channel is also performed, and later when the user instructs switching to an operation that does not require the CS tuner (for example, instruction for switching to the BS broadcasting channel), the relevant process (BS broadcasting receiving process) is performed and at the same time the power supply to the CS tuner is stopped.

### BRIEF DESCRIPTION OF THE DRAWINGS

FIG. 1 is a block diagram showing an overview of parts of a liquid crystal television broadcasting receiver related to the present invention;

FIG. 2 is a perspective view showing the appearance of a liquid crystal television broadcasting receiver;

FIG. 3 is a flow chart showing an overview of operations related to the present invention according to Embodiment 1;

FIG. 4 illustrates an example of a display screen;

FIG. 5 is a flowchart showing an overview of operations related to the present invention according to Embodiment 2;

FIG. 6 illustrates an example of a display screen; and

FIG. 7 is a flow chart showing an overview of other operations related to the present invention.

### DETAILED DESCRIPTION OF THE PREFERRED EMBODIMENTS

Hereinafter, specific embodiments of the present invention will be explained with reference to the attached drawings. Note that the following embodiments are ones that embody the present invention and are not intended to confine the present invention within the range thereof.

### Embodiment 1

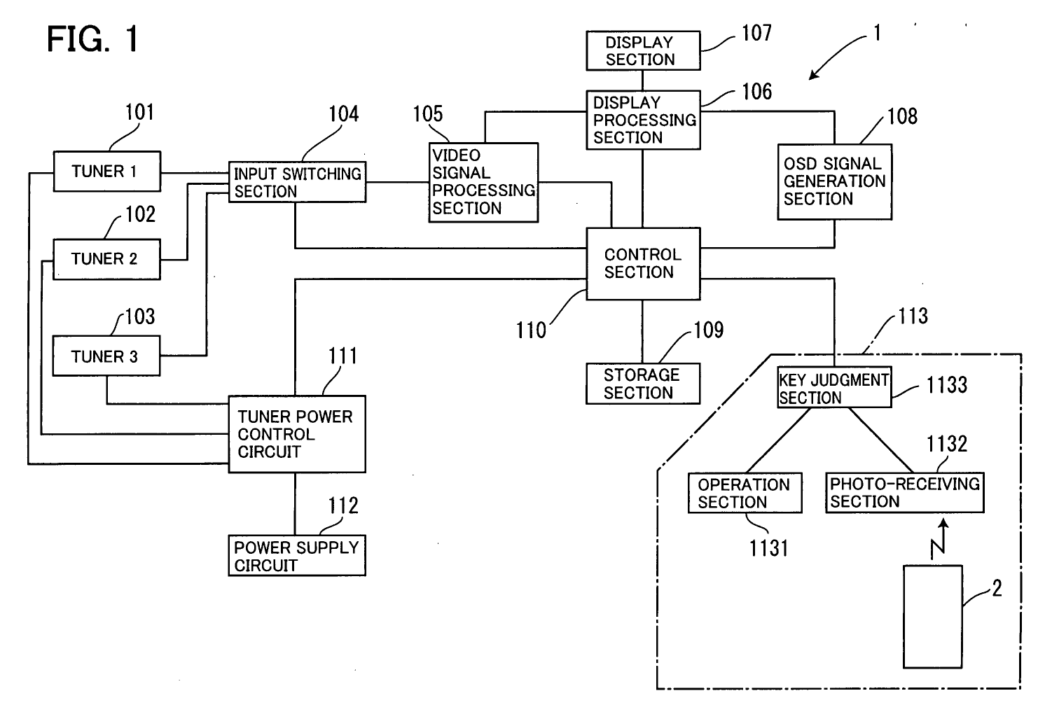

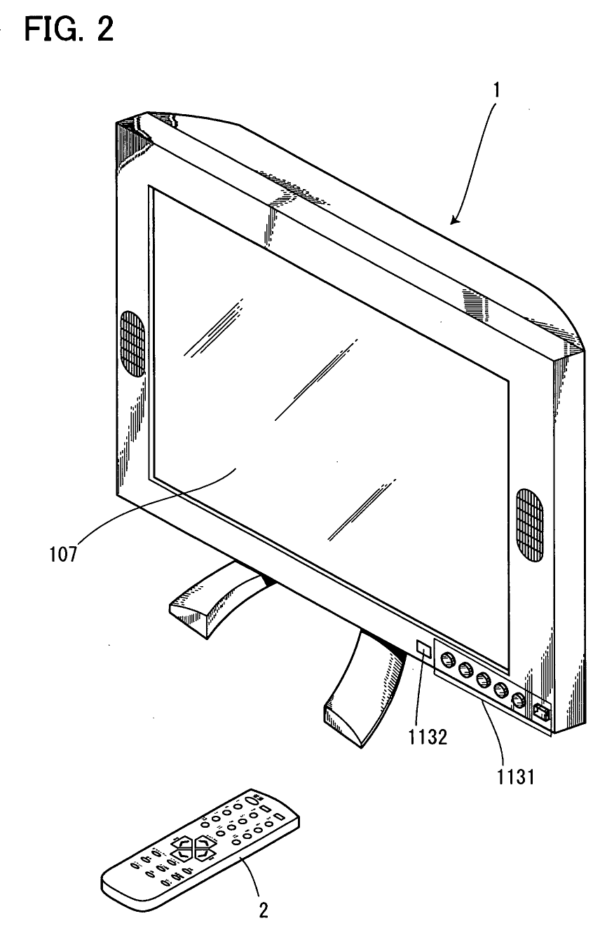

FIG. 1 is a block diagram showing an overview of parts of a liquid crystal television broadcasting receiver (hereinafter simply referred to as “LCD”) related to the present invention and FIG. 2 is a perspective view showing the appearance of the device.

As shown in FIG. 1, the LCD 1 of this embodiment is provided with tuners 101 to 103 which receive broadcast signals of various frequencies (terrestrial digital tuner 1, BS/CS 110° tuner 2, CS 124/128° tuner 3), an input switching section 104 which switches between input signals from these tuners 101 to 103, a video signal processing section 105 which processes a signal inputted from the input switching section 104 (for example, generation of a video signal to display video on a display section 107 (for example, RGB signal)), an on-screen display (hereinafter simply referred to as “OSD”) signal generation section 108 which generates an OSD signal, the display section 107, a display processing section 106 which performs processing such as superimposing of the OSD signal inputted from the OSD signal generation section 108 on the video signal inputted from the video signal processing section 105 and displays video on the display section 107, a storage section 109 which is storing means, a control section 110 which performs overall control of the device or the like, a tuner power control circuit 111 which controls power supplies to the respective tuners 101 to 103, a power supply section 112 and an input section 113 which is an input interface from the user (made up of an operation section 1131, a remote control device 2, a photo-receiving section 1132 which receives a signal from the remote control device 2, a key judgment section 1133 which judges the contents of a signal from the operation section 1131 or photo-receiving section 1132) or the like.

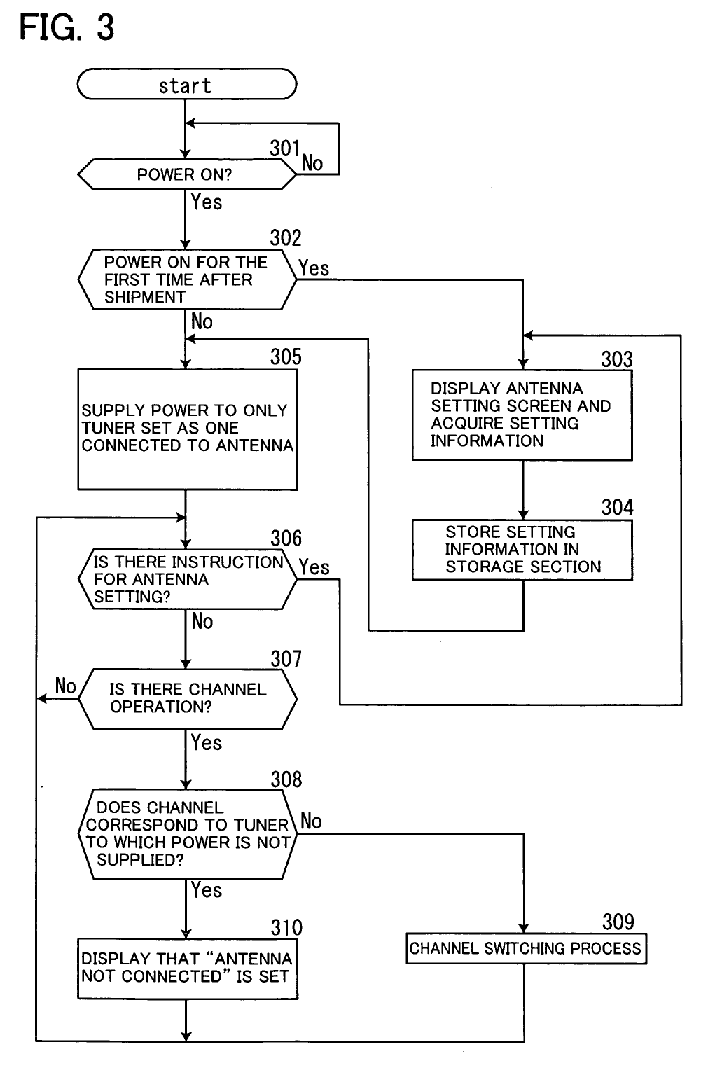

FIG. 3 is a flowchart showing an overview of operations related to the present invention of the LCD 1 of this embodiment. When the power of the device is turned ON (step 301), it is judged whether the power is turned ON for the first time after shipment or not (step 302). Such a judgment is made, for example, by providing a flag in the storage section 109, which is set to 0 before shipment and changed to 1 when power is turned ON for the first time and judging the value of the flag through the control section 110.

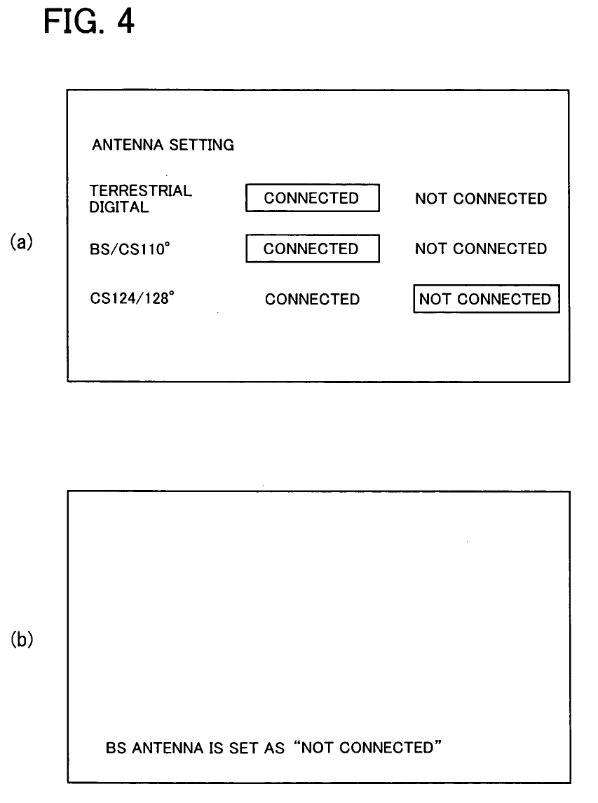

When the judgment in step 302 is positive (power is turned ON for the first time after shipment), an “antenna setting screen” shown in FIG. 4(a) is displayed on the display section 107, the user is prompted to set a connection status of each antenna, each piece of setting information is acquired (step 303) and the setting information is stored in storage section 109 (step 304). Such processing is performed by causing the control section 110, OSD signal generation section 108 and display processing section 106 to display a setting screen (while changing the display screen according to an input from the user) on the display section 107, judging the contents of the user's input to the remote control device 2 or operation section 1131 through the key judgment section 1133 and control section 110 and acquiring various pieces of setting information. The same concept also applies to the screen display process in the following processes or when the contents of operation by the user are judged.

The “antenna setting” is set as to whether an antenna is connected to each tuner or not as shown in FIG. 4(a), but as shown below, the “antenna setting” in the operation process in this embodiment is to set as to whether power is supplied to each tuner or not, and therefore even in the case of a tuner to which an antenna is connected, if the user judges that “this tuner will not be used”, the user may set the tuner as “not connected.”

In the case where powering ON of the device (step 301) is not the first time after shipment or after the processes in step 303 and step 304, the process moves to step 305, where the control section 110 and tuner power control circuit 111 control power supplies from the power supply section 112 to the respective tuners 101 to 103 according to the “antenna setting” stored in the storage section 109 (power is supplied to only tuners set as “connected”).

In step 306 and step 307, the process waits for an instruction from the user for a “channel change operation” or “change of antenna setting” and if a request for “change of antenna setting” is received, the process moves to step 303 (step 306), where information “antenna setting” is acquired and stored in the storage section 109. When the “channel change operation” is performed, the process moves to step 308 (step 307), where it is judged whether or not the channel is a channel which is received by a tuner to which power is not supplied (for example, when the BS broadcasting channel button of the remote control device 2 is inputted, it is judged whether or not the “antenna setting” for the BS/CS 110° tuner 2 is “not connected”). When the judgment in step 308 is negative (the selected channel is a channel which is received by a tuner to which power is supplied), a channel switching process is performed in step 309 and then the process moves back to step 306 and the above described processes are repeated. On the other hand, if the judgment in step 308 is positive (when the selected channel is a channel which is received by a tuner to which power is not supplied), the screen shown in FIG. 4(b) is displayed in step 310, the process moves back to step 306 and the above described processes are repeated.

In the process in step 310, no channel change process is performed and a message is displayed superimposed on the video being received before the channel operation. For example, when the BS broadcasting channel button is pressed while terrestrial broadcasting is being received (suppose the “antenna setting” for the BS/CS 110° tuner 2 is set to “not connected”), the receiving condition of terrestrial broadcasting is kept and the OSD signal generation section 108 generates an OSD signal indicating “BS antenna is set to “not connected””, this OSD signal is superimposed on the terrestrial broadcasting video being received by the display processing section 106 and displayed on the display section 107 (displayed for a certain time or the like) (this results in the screen display shown in FIG. 4(b) (a terrestrial broadcasting screen is shown in the background).

As described above, according to the LCD 1 in this embodiment, the user sets whether power is supplied to each tuner or not, and even when switching to, for example, the BS broadcasting channel is performed, it is possible to prevent the process for switching to the BS broadcasting channel from being performed, and therefore the processing for switching to a channel against the user's will (for example, the user has originally no intention to view BS broadcasting, yet has mistakenly pressed the button for the BS broadcasting channel) is not performed and information such as “BS antenna is not connected” is displayed on the screen when the relevant operation is requested, which offers excellent convenience to the user and prevents unnecessary power supplies to tuners and thereby reduces power consumption. Furthermore, when switching to broadcasting received by a specific tuner is preferably avoided (for example, when receiving of CS broadcasting by a television installed in an educational institute or the like is preferably avoided, or on the contrary, when receiving of only CS broadcasting is preferably allowed), “antenna setting” of the relevant tuner is set to “not connected” to prevent switching to the broadcasting channel received by a specific tuner, which offers excellent convenience to the user.

### Embodiment 2

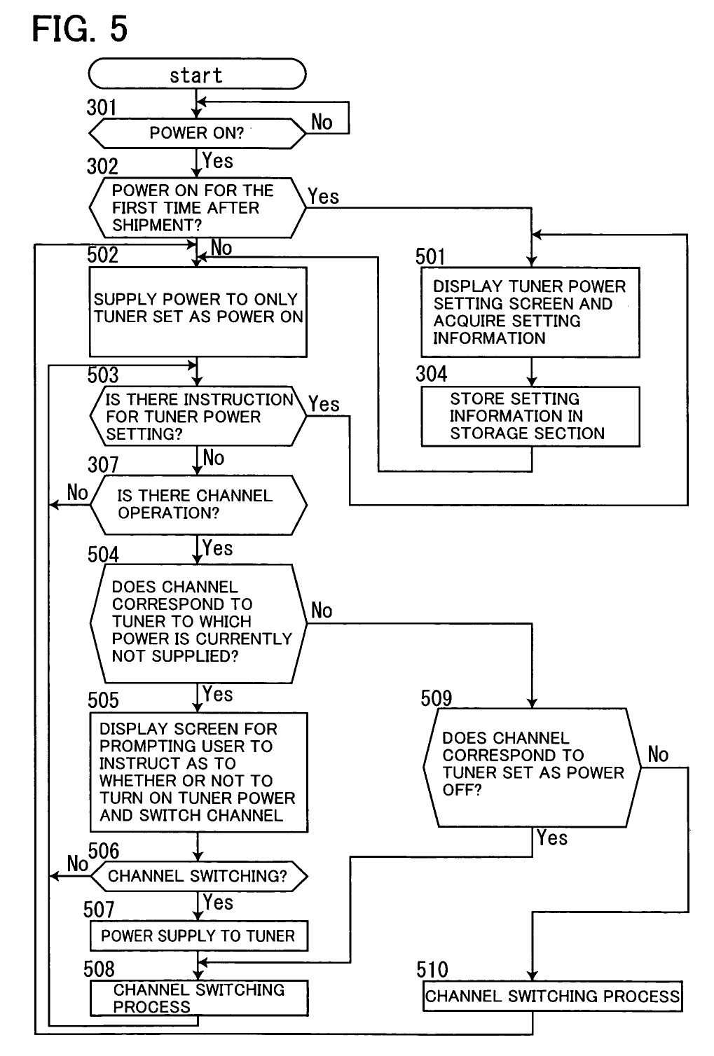

FIG. 5 is a flow chart showing an overview of operations of an LCD related to the present invention according to this embodiment. Parts having concepts of processing similar to those in Embodiment 1 (FIG. 3) are assigned the same reference numerals as those in Embodiment 1 and explanations thereof are simplified or omitted here. The configuration of the LCD in this embodiment is similar to that of Embodiment 1 and explanations thereof will be omitted here and explained with reference to FIG. 1 whenever required.

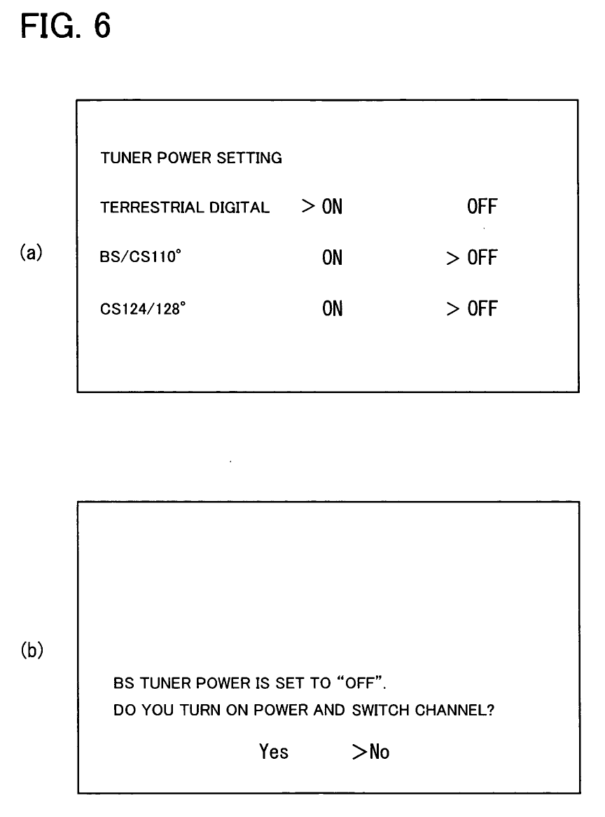

The processing concept from step 301 to step 307 is basically the same as that in Embodiment 1 (FIG. 3), but in this embodiment, the user is prompted to directly perform “setting of tuner power supply” and in the process in step 501, a screen as shown in FIG. 6(a) is displayed and “setting of tuner power supply” is also performed in step 502 and step 503.

When the judgment in step 307 (FIG. 5) is positive (when there is a “channel change operation”), the process moves to step 504, where it is judged whether or not the relevant channel is a channel received by a tuner to which power is currently not supplied. Such a judgment is made by judging the current status of a tuner power control circuit 111 (to which tuner power is supplied) through a control section 110. As a result, if the channel is a channel received by a tuner to which power is currently not supplied, a screen as shown in FIG. 6(b) is displayed in step 505, and if an instruction from the user in response thereto is “channel switching” (step 506), a power supply process on the “tuner to which power is currently not supplied” is performed by the control section 110 and tuner power control circuit 111 (step 507) and a channel switching process is performed (step 508). On the other hand, when the judgment result in step 506 is negative (channel switching is not performed), the process moves back to step 503 without performing the “process to start power supply to the tuner (step 507)” and “channel switching process (step 508)” and the processes are repeated.

When the judgment result in step 504 is negative (when the channel is a channel received by a tuner to which power is currently supplied), the process moves to step 509 and it is judged whether or not the channel subjected to a channel operation is a channel received by a tuner whose power supply is set to “OFF” (the setting stored in storage section 109). When the judgment result shows that the power supply is set to “OFF”, the process moves to step 508, while the power supply is set to “ON”, a channel switching process is performed in step 510 and then the process moves to step 502 and the processes are repeated thereafter.

The above described processing concept will be explained with a specific example. A case where “tuner power supply setting” for a terrestrial digital tuner 1 is set to “ON” and “tuner power setting” is set to “OFF” for a BS/CS 110° tuner 2 will be explained as an example. With such a setting, when power is not supplied to the BS/CS 110° tuner 2 (for example, when a terrestrial digital broadcasting channel is being viewed), if the BS broadcasting channel button is pressed, the process moves from step 504 to step 505, and if the user instructs “channel switching” on the instruction screen (FIG. 6(b)) in step 505, a power supply to the BS/CS 110° tuner 2 is started in step 507, a BS broadcasting channel is received (viewed) (step 508) and then the process moves to a “loop for waiting an instruction on “channel change operation” or “change of tuner power setting”” in step 503 and step 307.

If another BS broadcasting channel button is pressed in this condition (while a BS broadcasting channel is being viewed), the process moves from step 504 to step 509 (because power is supplied to the BS/CS 110° tuner 2) and moves from step 509 to step 508 (because the “tuner power setting” of the BS/CS 110° tuner 2 is set to “OFF”). In this way, switching to “another BS broadcasting channel” is performed and then the process moves to the “loop for waiting an instruction on “channel change operation” or “change of tuner power setting”” in step 503 and step 307.

On the other hand, when the terrestrial digital broadcasting channel button is pressed in this condition (when a BS broadcasting channel is being viewed), the process moves from step 504 to step 509, and to step 502 through step 509 and step 510. In this way, switching to the “terrestrial digital broadcasting channel” is performed and then the power supply to the BS/CS 110° tuner 2 is stopped in step 502.

As described above, according to this embodiment, if an operation of switching to the BS broadcasting channel is performed in a situation in which a setting is made so as to turn OFF the power to the BS tuner, the user is prompted to decide whether or not power is supplied to the BS tuner (whether or not the channel is switched), and if the user gives an instruction for performing a power supply, the power is supplied to the BS tuner as an exceptional process (the power to the BS tuner is turned OFF again when the viewing of the BS broadcasting channel is completed) and switching to the BS broadcasting channel is also performed. Thus, depending on the situation in which the device is used, this offers excellent convenience to the user compared to uniformly “disabling switching to a BS broadcasting channel” according to the setting. It is also possible to allow the user to set a password beforehand and prompt the user to input the password when urging the user to judge whether or not power should be supplied (whether or not the channel is switched) or when making a tuner power setting and thereby prevent the “user” from viewing broadcasting against the intention of an “administrator.”

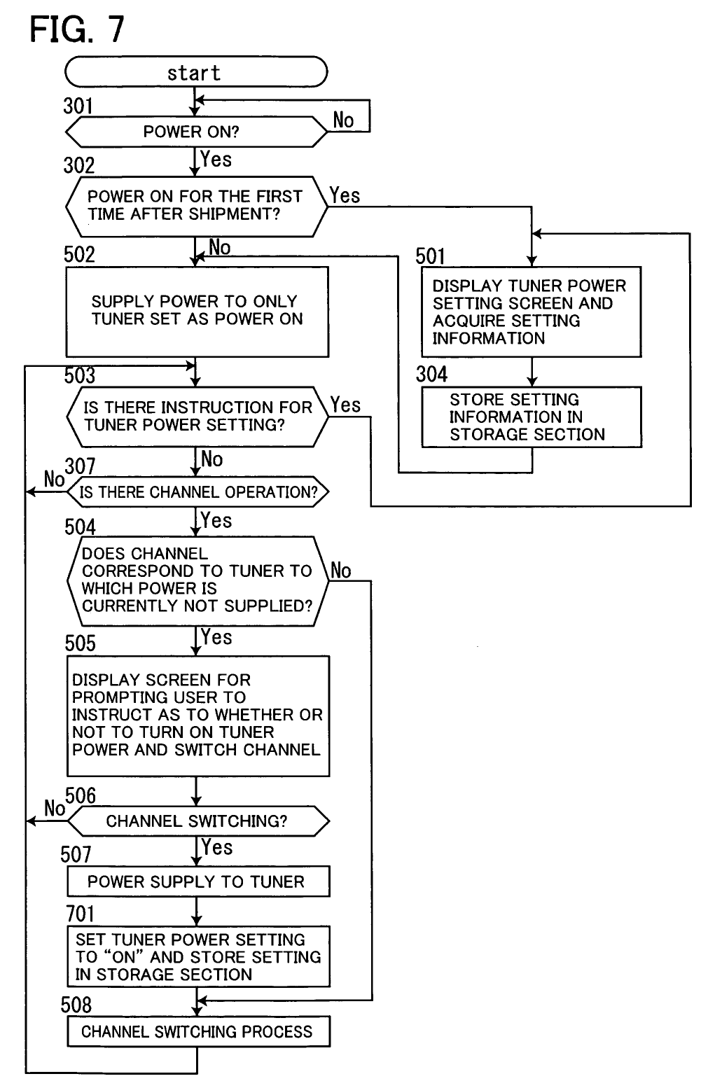

FIG. 7 shows another processing example. In this processing, in step 701 following step 507 (when switching is performed to a channel received by a tuner to which power is not supplied and the user instructs switching to the channel), the “tuner power setting” of the tuner is turned “ON” and the setting is stored in the storage section 109. Furthermore, when the judgment in step 504 is negative (when switching is performed to a channel received by a tuner to which power is supplied), the process moves to step 508, where the channel is simply switched and the process moves back to the loop between step 503 and step 307.

Through such processes, when the user requests receiving of the tuner (channel switching request) whose “tuner power setting” is set to “OFF”, the “tuner power setting” is turned “ON” to reflect the instruction and the setting is stored in the storage section 109.

The “television broadcasting receiver” according to the present invention is not limited to a so-called television receiver, but it only needs to be a “device provided with a plurality of tuners for receiving different broadcast signals” and, for example, it can be a recording/reproducing device such as a so-called DVD recorder or personal computer.

The effects of the present invention are as follows.

According to the first aspect of the present invention, which is a television broadcasting receiver provided with a plurality of tuners for receiving broadcast signals of various frequencies, comprising a control section, a storage section, a tuner power control circuit which controls power supplies to the respective tuners and an input section which is an interface for inputs from a user, wherein the user's settings as to whether or not power is supplied to the respective tuners are acquired from the input section, the settings are stored in the storage section and the tuner power control circuit controls power supplies to the respective tuners, the user sets as to whether or not power is supplied to the respective tuners and the power supplies to the respective tuners are controlled according to the setting contents, and therefore it is possible to prevent power from being supplied to an unnecessary tuner against the user's will (in a case of misoperation or in a case against the will of an “administrator” who desires to provide restrictions on the use by “users”). Therefore, this offers excellent convenience to the user and also reduces power consumption.

According to the third aspect of the present invention, which is the television broadcasting receiver according to the first or second aspect of the present invention, wherein when the input from the user to the input section is an instruction for switching to receiving of another broadcast signal and when the tuner which receives the other broadcast signal is a tuner set so as not to perform the power supply, the switching to the receiving of the other broadcast signal is not performed, even when, for example, an operation of switching to a CS broadcasting channel is performed, it is possible to prevent the switching to the CS broadcasting channel from being performed and thereby prevent switching to a channel (for example, CS broadcasting) against the user's will (in a case of misoperation or in a case against the will of an “administrator” who desires to provide restrictions on the use by “users”), which offers excellent convenience to the user and also reduces power consumption.

According to the fourth aspect of the present invention, which is the television broadcasting receiver according to the third aspect of the present invention, wherein when an instruction for switching to the receiving of the other broadcast signal is given and the tuner which receives the other broadcast signal is a tuner set so as not to perform the power supply, information thereon is displayed on a screen, even when, for example, an operation of switching to a CS broadcasting channel is performed, it is possible to prevent the switching to the CS broadcasting channel from being performed and such information that “the power supply to the CS tuner has been set to “OFF”” is displayed on a screen when such an operation is required, which offers excellent convenience to the user.

According to the fifth aspect of the present invention, which is the television broadcasting receiver according to the first or second aspect of the present invention, wherein when the input from the user to the input section is an instruction for switching to receiving of another broadcast signal and the tuner which receives the other broadcast signal is a tuner set so as not to perform the power supply, the user is prompted to instruct as to whether or not power is supplied to the tuner to which the power is not supplied and if the instruction from the user to the input section in response thereto is to supply power to the tuner, the tuner power control circuit performs processing of supplying power to the tuner and performs switching to the receiving of the other broadcast signal, when, for example, an operation of switching to a CS broadcasting channel is performed while a power supply to the CS tuner has been set to “OFF”, the user is prompted to instruct as to whether or not power is supplied to the CS tuner and if the user instructs that power should be supplied, power is supplied to the CS tuner as an exceptional process and switching to the CS broadcasting channel is performed. Thus, depending on the situation in which the device is used, this offers excellent convenience to the user compared to uniformly “disabling switching to a BS broadcasting channel” according to the setting.

1. A television broadcasting receiver provided with a plurality of tuners for receiving broadcast signals of various frequencies, comprising:
a control section;
a storage section;
a tuner power control circuit which controls power supplies to the respective tuners; and
an input section which is an interface for inputs from a user,
wherein the user's settings as to whether or not power is supplied to the respective tuners are acquired from the input section, the settings are stored in the storage section and the tuner power control circuit controls power supplies to the respective tuners.

2. The television broadcasting receiver according to claim 1, wherein the user is prompted to enter settings as to whether or not power is supplied to the respective tuners at the time of initial setting to use the television broadcasting receiver.

3. The television broadcasting receiver according to claim 1, wherein when the input from the user to the input section is an instruction for switching to receiving of another broadcast signal and when the tuner which receives the other broadcast signal is a tuner set so as not to perform the power supply, the switching to the receiving of the other broadcast signal is not performed.

4. The television broadcasting receiver according to claim 3, wherein when an instruction for switching to the receiving of the other broadcast signal is given and the tuner which receives the other broadcast signal is a tuner set so as not to perform the power supply, information thereon is displayed on a screen.

5. The television broadcasting receiver according to claim 1, wherein when the input from the user to the input section is an instruction for switching to receiving of another broadcast signal and the tuner which receives the other broadcast signal is a tuner set so as not to perform the power supply, the user is prompted to instruct as to whether or not power is supplied to the tuner to which the power is not supplied and if the instruction from the user to the input section in response thereto is to supply power to the tuner, the tuner power control circuit performs processing of supplying power to the tuner and performs switching to the receiving of the other broadcast signal.

6. The television broadcasting receiver according to claim 5, wherein when the user instructs that power should be supplied to the tuner which receives the other broadcast signal, the storage section is caused to store a setting that the power supply to the tuner is set to “ON”.

7. The television broadcasting receiver according to claim 5, wherein when the user instructs that power should be supplied to the tuner which receives the other broadcast signal, the setting that the power supply to the tuner is set to “OFF” stored in the storage section is not changed and when the user instructs switching to an operation process that does not require the tuner, the operation process is performed and the power supply to the tuner by the tuner power control circuit is stopped.

8. The television broadcasting receiver according to claim 2, wherein when the input from the user to the input section is an instruction for switching to receiving of another broadcast signal and when the tuner which receives the other broadcast signal is a tuner set so as not to perform the power supply, the switching to the receiving of the other broadcast signal is not performed.

9. The television broadcasting receiver according to claim 8, wherein when an instruction for switching to the receiving of the other broadcast signal is given and the tuner which receives the other broadcast signal is a tuner set so as not to perform the power supply, information thereon is displayed on a screen.

10. The television broadcasting receiver according to claim 2, wherein when the input from the user to the input section is an instruction for switching to receiving of another broadcast signal and the tuner which receives the other broadcast signal is a tuner set so as not to perform the power supply, the user is prompted to instruct as to whether or not power is supplied to the tuner to which the power is not supplied and if the instruction from the user to the input section in response thereto is to supply power to the tuner, the tuner power control circuit performs processing of supplying power to the tuner and performs switching to the receiving of the other broadcast signal.

11. The television broadcasting receiver according to claim 10, wherein when the user instructs that power should be supplied to the tuner which receives the other broadcast signal, the storage section is caused to store a setting that the power supply to the tuner is set to “ON”.

12. The television broadcasting receiver according to claim 10, wherein when the user instructs that power should be supplied to the tuner which receives the other broadcast signal, the setting that the power supply to the tuner is set to “OFF” stored in the storage section is not changed and when the user instructs switching to an operation process that does not require the tuner, the operation process is performed and the power supply to the tuner by the tuner power control circuit is stopped.
